(19) United States
(12) Patent Application Publication
(10) Pub. No.: US 2024/0356162 A1
(43) Pub. Date: Oct. 24, 2024

(54) SECONDARY BATTERY

(71) Applicant: MURATA MANUFACTURING CO., LTD., Kyoto (JP)

(72) Inventor: Masayuki KAGEYAMA, Kyoto (JP)

(21) Appl. No.: 18/427,492

(22) Filed: Jan. 30, 2024

Related U.S. Application Data
(63) Continuation of application No. PCT/JP2022/037490, filed on Oct. 6, 2022.

(30) Foreign Application Priority Data
Oct. 11, 2021 (JP) 2021-166922

(51) Int. Cl. H01M 50/474; H01M 10/0525; H01M 50/109; H01M 50/119; H01M 50/153; H01M 50/186; H01M 50/548

(52) U.S. Cl. CPC H01M 50/474; H01M 10/0525; H01M 50/109; H01M 50/119; H01M 50/153; H01M 50/186; H01M 50/548

(57) ABSTRACT

A secondary battery includes an outer package member, an electrode terminal, an insulating sealing member, a battery device, and an insulating member. The outer package member has an electrically conductive property and has a through hole. The electrode terminal is disposed on an outer side of the outer package member and blocks the through hole. The insulating sealing member is disposed between the outer package member and the electrode terminal. The battery device is contained inside the outer package member. The insulating member is disposed between the outer package member and the battery device. The outer package member includes a recessed part in which the through hole is provided. In the recessed part, the outer package member is bent to be recessed inward. The recessed part has an opposed surface opposed to the battery device. The insulating member covers the opposed surface and is fixed to the opposed surface.

### CROSS REFERENCE TO RELATED APPLICATIONS

The present application is a continuation of PCT patent application no. PCT/JP2022/037490, filed on Oct. 6, 2022, which claims priority to Japanese patent application no. 2021-166922, filed on Oct. 11, 2021, the entire contents of which are incorporated herein by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device (a positive electrode, a negative electrode, and an electrolyte) inside an outer package member. A configuration of the secondary battery has been considered in various ways.

For example, an electrode body is contained inside an outer casing, and a flat-plate shaped electrode terminal member is disposed on an outer side of a casing body, with a seal member interposed between the flat-plate shaped electrode terminal member and the casing body. Further, for example, an electrode body is contained inside an exterior body, and the exterior body has a laminated structure including a resin layer and a metal layer. Also, for example, power generating elements are contained inside a battery case that is closed by a cover plate, and an electrode terminal is disposed on the cover plate with an insulator interposed between the electrode terminal and the cover plate.

### SUMMARY

The present application relates to a secondary battery.

Although consideration has been given in various ways in relation to a configuration of a secondary battery, a capacity characteristic and operational stability of the secondary battery still remain insufficient. Accordingly, there is room for improvement in terms thereof.

It is therefore desirable to provide a secondary battery that makes it possible to achieve, for example, both a superior capacity characteristic and superior operational stability.

A secondary battery according to an embodiment of the present technology includes an outer package member, an electrode terminal, an insulating sealing member, a battery device, and an insulating member. The outer package member has an electrically conductive property and has a through hole. The electrode terminal is disposed on an outer side of the outer package member and blocks the through hole. The insulating sealing member is disposed between the outer package member and the electrode terminal. The battery device is contained inside the outer package member. The insulating member is disposed between the outer package member and the battery device. The outer package member includes a recessed part in which the through hole is provided. In the recessed part, the outer package member is bent to be recessed inward. The recessed part has an opposed surface opposed to the battery device. The insulating member covers the opposed surface and is fixed to the opposed surface.

According to the secondary battery of an embodiment of the present technology, the battery device is contained inside the electrically conductive outer package member having the through hole. The electrode terminal disposed on the outer side of the outer package member blocks the through hole. The insulating sealing member is disposed between the outer package member and the electrode terminal. The recessed part having the through hole is provided in the outer package member. The insulating member covers the opposed surface of the recessed part, and is fixed to the opposed surface. Accordingly, it is possible to achieve both a superior capacity characteristic and superior operational stability.

Note that effects of the present technology are not necessarily limited to those described herein and may include any suitable effect, including described below, in relation to the present technology.

### BRIEF DESCRIPTION OF THE FIGURES

FIG. 1 is a perspective view of a configuration of a secondary battery according to an embodiment of the present technology.

FIG. 2 is an enlarged sectional view of the configuration of the secondary battery illustrated in FIG. 1.

FIG. 3 is an enlarged sectional view of a configuration of a battery device illustrated in FIG. 2.

FIG. 4 is a plan view of a configuration of a main part of the secondary battery illustrated in FIG. 2.

FIG. 5 is a sectional diagram for describing an operation of the secondary battery.

FIG. 6 is a perspective diagram for describing a process of manufacturing the secondary battery.

FIG. 7 is an enlarged sectional view of a configuration of a secondary battery of Comparative example 1.

FIG. 8 is an enlarged sectional view of a configuration of a secondary battery of Comparative example 2.

FIG. 9 is an enlarged sectional view of a configuration of a secondary battery of Comparative example 3.

FIG. 10 is an enlarged sectional view of a configuration of a secondary battery of Comparative example 4.

FIG. 11 is a plan view of a configuration of a main part of the secondary battery illustrated in FIG. 10.

FIG. 12 is an enlarged sectional view of a configuration of a secondary battery of an embodiment.

FIG. 13 is a plan view of a configuration of a main part of the secondary battery illustrated in FIG. 12.

FIG. 14 is an enlarged sectional view of a configuration of a secondary battery of an embodiment.

FIG. 15 is a plan view of a configuration of a main part of the secondary battery illustrated in FIG. 14.

FIG. 16 is an enlarged sectional view of a configuration of a secondary battery of an embodiment.

FIG. 17 is an enlarged sectional view of a configuration of a secondary battery of an embodiment.

### DETAILED DESCRIPTION

The present technology will be described below in further detail including with reference to the drawings.

A description is given first of a secondary battery according to an embodiment of the present technology.

The secondary battery to be described here is a secondary battery of a type referred to as a coin type or a button type.

As will be described later, the secondary battery has two bottom parts opposed to each other, and a sidewall part coupled to each of the two bottom parts. Further, the secondary battery has an outer diameter and a height. The height is smaller than the outer diameter. The “outer diameter” is a diameter (a maximum diameter) of each of the two bottom parts, and the “height” is a distance (a maximum distance) from one of the bottom parts to another of the bottom parts.

Although a charge and discharge principle of the secondary battery is not particularly limited, the following description deals with a case where a battery capacity is obtained using insertion and extraction of an electrode reactant.

The secondary battery includes a positive electrode, a negative electrode, and an electrolyte. The negative electrode has a charge capacity greater than a discharge capacity of the positive electrode. In other words, an electrochemical capacity per unit area of the negative electrode is set to be greater than an electrochemical capacity per unit area of the positive electrode. A reason for this is to prevent the electrode reactant from precipitating on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

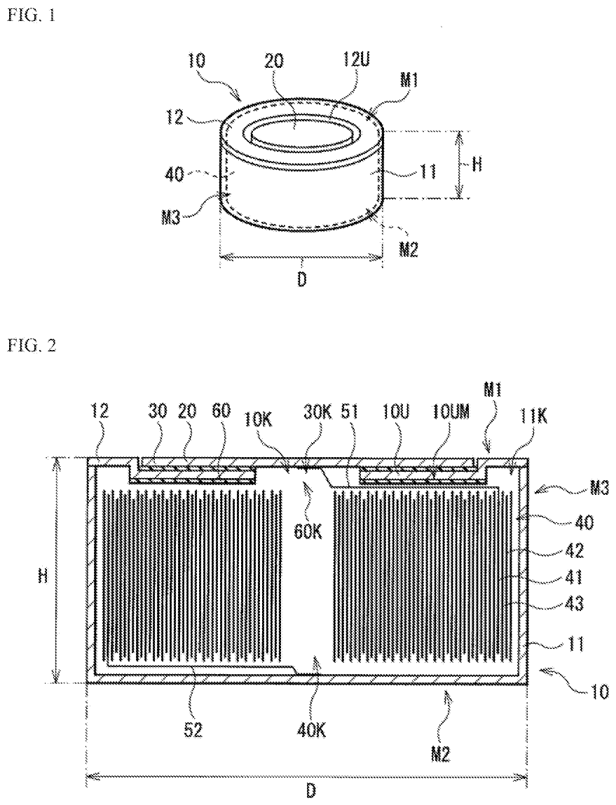

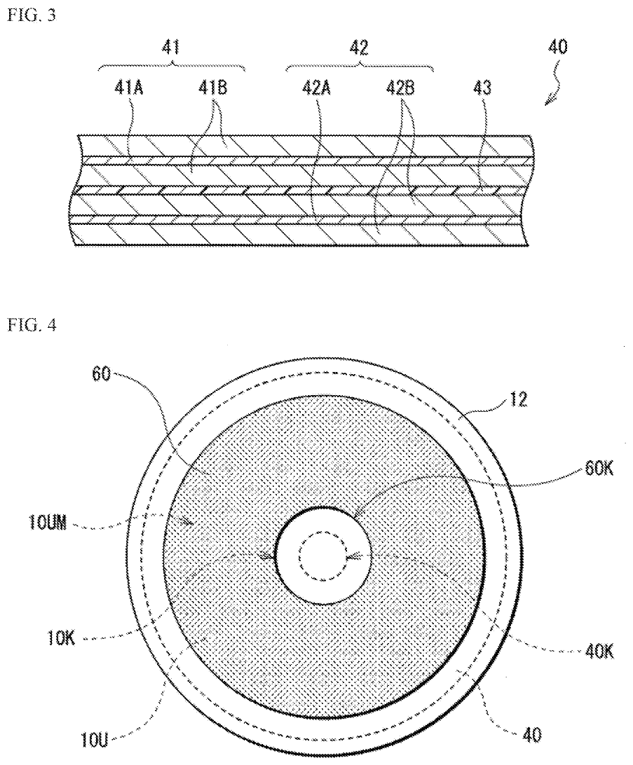

FIG. 1 illustrates a perspective configuration of the secondary battery. FIG. 2 illustrates an enlarged sectional configuration of the secondary battery illustrated in FIG. 1. FIG. 3 illustrates an enlarged sectional configuration of a battery device 40 illustrated in FIG. 2. FIG. 4 illustrates a planar configuration of a main part of the secondary battery illustrated in FIG. 2.

For convenience, the following description is given with an upper side in FIG. 2 assumed to be an upper side of the secondary battery, and a lower side in FIG. 2 assumed to be a lower side of the secondary battery.

Note that in FIG. 2, for simplifying the illustration, a positive electrode 41, a negative electrode 42, a separator 43, a positive electrode lead 51, and a negative electrode lead 52 are each depicted in a linear shape. Further, FIG. 3 illustrates only a portion of the battery device 40.

FIG. 4 illustrates only a cover part 12, the battery device 40, and an insulating film 60. FIG. 4 illustrates a state in which the cover part 12 and the insulating film 60 are each viewed from the lower side, and indicates each of an outer edge and an inner edge (a winding center space 40K) of the battery device 40 in a broken line.

As illustrated in FIGS. 1 and 2, the secondary battery to be described here is a secondary battery of a button type, and has an outer diameter D and a height H. The secondary battery has a three-dimensional shape in which the height H is smaller than the outer diameter D, that is, a flat and columnar three-dimensional shape. Here, the three-dimensional shape of the secondary battery is flat and cylindrical (circular columnar), and a ratio D/H of the outer diameter D to the height H is greater than 1.

Specific dimensions of the secondary battery are not particularly limited; however, for example, it is preferable that the outer diameter D fall within a range from 3 mm to 30 mm both inclusive and the height H fall within a range from 0.5 mm to 70 mm both inclusive. Note that the ratio D/H is preferably less than or equal to 25.

As illustrated in FIGS. 1 to 4, the secondary battery includes an outer package can 10, an external terminal 20, a gasket 30, the battery device 40, the positive electrode lead 51, the negative electrode lead 52, and the insulating film 60.

As illustrated in FIGS. 1 and 2, the outer package can 10 is a hollow outer package member to contain the battery device 40 and other components. The outer package can 10 has a through hole 10K.

Here, the outer package can 10 has a three-dimensional shape similar to the three-dimensional shape of the secondary battery, that is, a flat and columnar (circular columnar) three-dimensional shape. The outer package can 10 thus has an upper bottom part M1 and a lower bottom part M2 opposed to each other, and a sidewall part M3. The sidewall part M3 is disposed between the upper bottom part M1 and the lower bottom part M2 and coupled to each of the upper bottom part M1 and the lower bottom part M2. The outer package can 10 has a flat and circular columnar three-dimensional shape as described above. Thus, the upper bottom part M1 and the lower bottom part M2 are each circular in plan shape, and a surface of the sidewall part M3 is a curved surface that is convex outward.

An inner diameter of the through hole 10K may be the same as or different from an inner diameter of the winding center space 40K to be described later. FIG. 2 illustrates a case where the inner diameter of the through hole 10K is larger than the inner diameter of the winding center space 40K.

The outer package can 10 includes a recessed part 10U, and the through hole 10K is provided in the recessed part 10U. In the recessed part 10U, the outer package can 10 is bent to be recessed inward. Accordingly, a portion of the outer package can 10 is bent to form a downward step.

The recessed part 10U thus has an opposed surface 10UM opposed to the battery device 40. The opposed surface 10UM is a bottommost surface of the cover part 12, that is, a bottom surface of a portion (the recessed part 10U), of the cover part 12, that is closest to the battery device 40. Note that a region in which the through hole 10K is present is excluded from the opposed surface 10UM for the reason that the recessed part 10U is absent in the through hole 10K.

A shape of the recessed part 10U, that is, a shape defined by an outer edge of the recessed part 10U when the secondary battery is viewed from above is not particularly limited. Here, the recessed part 10U has a circular shape. An inner diameter and a depth of the recessed part 10U are not particularly limited and may be chosen as desired.

Here, the outer package can 10 includes a container part 11 and the cover part 12. The container part 11 and the cover part 12 are joined to each other. Specifically, the container part 11 and the cover part 12 are welded to each other. The container part 11 is thus sealed by the cover part 12.

The container part 11 is a circular columnar and substantially bowl-shaped member (the lower bottom part M2 and the sidewall part M3) to contain the battery device 40 and other components inside. Here, the container part 11 has a structure in which the lower bottom part M2 and the sidewall part M3 are integral with each other. The container part 11 has a hollow structure with an upper end open and a lower end closed, and thus has an opening 11K at the upper end.

The cover part 12 is a substantially disk-shaped member (the upper bottom part M1) to close the opening 11K, and includes the recessed part 10U having the through hole 10K. As will be described later, the through hole 10K is used as a coupling path for electrically coupling the battery device 40 and the external terminal 20 to each other.

In the secondary battery as completed, the cover part 12 has already been joined to the container part 11 as described above, and the opening 11K has thus been closed by the cover part 12. It may thus seem that whether the container part 11 has had the opening 11K is not recognizable afterward from an external appearance of the secondary battery.

If, however, the container part 11 and the cover part 12 have been welded to each other to join the container part 11 and the cover part 12 to each other in a process of manufacturing the secondary battery, welding marks should remain on a surface of the outer package can 10, more specifically, at a boundary between the container part 11 and the cover part 12. Thus, whether the container part 11 has had the opening 11K is recognizable afterward, based on the presence or absence of the welding marks.

If the welding marks remain on the surface of the outer package can 10 and the welding marks are therefore visually recognizable, it indicates that the container part 11 has had the opening 11K. In contrast, if no welding marks remain on the surface of the outer package can 10 and no welding marks are therefore visually recognizable, it indicates that the container part 11 has had no opening 11K.

As described above, the outer package can 10 includes two members (the container part 11 and the cover part 12) that have been physically separate from each other and are joined to each other. Thus, the outer package can 10 is what is called a joined can. More specifically, the outer package can 10 in which the container part 11 and the cover part 12 are welded to each other is what is called a welded can. Accordingly, the outer package can 10 after joining is physically a single member as a whole, and is in a state of being not separable into the two members (the container part 11 and the cover part 12) afterward.

The outer package can 10 that is a joined can is different from a crimped can formed by means of crimping processing, and is thus what is called a crimpless can. A reason for this is to increase a device space volume inside the outer package can 10 and to thereby increase a volumetric energy density. The “device space volume” refers to a volume (an effective volume) of an internal space of the outer package can 10 available for containing the battery device 40.

Further, the outer package can 10 that is a joined can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state in which two or more members lie over each other and are so combined with each other as to be separable from each other afterward.

The outer package can 10 has an electrically conductive property, and therefore the container part 11 and the cover part 12 each have an electrically conductive property. The outer package can 10 is coupled to the battery device 40, more specifically, to the negative electrode 42 to be described later, via the negative electrode lead 52. Accordingly, the outer package can 10 is electrically coupled to the negative electrode 42. The outer package can 10 thus serves as an external coupling terminal of the negative electrode 42. A reason for this is to make it unnecessary for the secondary battery to include an external coupling terminal of the negative electrode 42 separate from the outer package can 10, and to thereby suppress a decrease in device space volume resulting from providing the external coupling terminal of the negative electrode 42. As a result, the device space volume increases, and the volumetric energy density increases accordingly.

The outer package can 10 includes any one or more of electrically conductive materials including, without limitation, a metal material and an alloy material. Specific examples of the electrically conductive materials include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

In particular, the outer package can 10 is preferably what is called a metal can. A reason for this is to improve rigidity of the outer package can 10, and to thereby suppress deformation of the outer package can 10. The metal can is a can including any one or more of the metal materials and the alloy materials described above.

As will be described later, the cover part 12 is insulated, via the gasket 30, from the external terminal 20 serving as an external coupling terminal of the positive electrode 41. A reason for this is to prevent contact, or a short circuit, between the outer package can 10 (the external coupling terminal of the negative electrode 42) and the external terminal 20 (the external coupling terminal of the positive electrode 41).

As illustrated in FIGS. 1 and 2, the external terminal 20 is an electrode terminal to be coupled to electronic equipment when the secondary battery is mounted on the electronic equipment. The external terminal 20 is disposed on an outer side of the outer package can 10 and blocks the through hole 10K.

Note that the external terminal 20 is supported by the outer package can 10 with the gasket 30 interposed between the external terminal 20 and the outer package can 10. More specifically, as will be described later, the external terminal 20 is thermally welded to the cover part 12 with the gasket 30 interposed between the external terminal 20 and the cover part 12. As a result, the external terminal 20 is fixed to the cover part 12 with the gasket 30 interposed between the external terminal 20 and the cover part 12, and is insulated from the cover part 12 by the gasket 30.

The external terminal 20 is coupled to the battery device 40 (the positive electrode 41) via the positive electrode lead 51, and is thus electrically coupled to the positive electrode 41. Accordingly, the external terminal 20 serves as the external coupling terminal of the positive electrode 41. Upon use of the secondary battery, the secondary battery is coupled to electronic equipment via the external terminal 20 (the external coupling terminal of the positive electrode 41) and the outer package can 10 (the external coupling terminal of the negative electrode 42). This allows the electronic equipment to operate with use of the secondary battery as a power source.

Further, the external terminal 20 is a substantially plate-shaped member. Specifically, a three-dimensional shape of the external terminal 20 is a flat plate shape, although not particularly limited thereto.

A portion or all of the external terminal 20 is disposed inside the recessed part 10U. Here, all of the external terminal 20 is disposed inside the recessed part 10U, that is, all of the external terminal 20 is disposed inside a space surrounded by the recessed part 10U. Thus, the external terminal 20 is so contained inside the recessed part 10U as not to protrude outward (upward) from the recessed part 10U.

The outer package can 10 includes the recessed part 10U, and the external terminal 20 is contained inside the recessed part 10U. A reason for this is to increase the volumetric energy density, and to thereby increase the battery capacity.

To be more specific, when the external terminal 20 is not contained inside the recessed part 10U, a portion of the external terminal 20 protrudes outward from the recessed part 10U. In this case, while a volume (an area in which the positive electrode 41 and the negative electrode 42 are opposed to each other) of the battery device 40 contained inside the outer package can 10 does not change, the height H increases by an amount of the external terminal 20 protruding outward from the recessed part 10U. This decreases the volumetric energy density, and therefore decreases the battery capacity.

In contrast, when the external terminal 20 is contained inside the recessed part 10U, the external terminal 20 does not protrude outward from the recessed part 10U. In this case, the volume of the battery device 40 contained inside the outer package can 10 does not change, and the height H does not increase. This increases the volumetric energy density, and thereby increases the battery capacity.

Note that the external terminal 20 has an outer diameter smaller than the inner diameter of the recessed part 10U. The external terminal 20 is thus separated from the cover part 12 surrounding the external terminal 20. Accordingly, the gasket 30 is disposed in at least a portion of a space between the cover part 12 and the external terminal 20 inside the recessed part 10U. More specifically, the gasket 30 is disposed at a location where the cover part 12 and the external terminal 20 would be in contact with each other if it were not for the gasket 30.

The external terminal 20 includes any one or more of electrically conductive materials including, without limitation, a metal material and an alloy material. Specific examples of the electrically conductive materials include aluminum and an aluminum alloy.

Note that the external terminal 20 may include a cladding material. The cladding material includes an aluminum layer and a nickel layer that are disposed in this order from a side close to the gasket 30. The aluminum layer and the nickel layer are roll-bonded to each other. Note that the cladding material may include a nickel alloy layer instead of the nickel layer. Alternatively, the cladding material may include an aluminum layer, a stainless steel (SUS) layer, and a nickel layer that are disposed in this order from the side close to the gasket 30. The aluminum layer, the stainless steel layer, and the nickel layer may be roll-bonded to each other.

In addition to serving as the external coupling terminal of the positive electrode 41, the external terminal 20 serves, in particular, as a release valve that releases an internal pressure of the outer package can 10 when the internal pressure excessively increases. Examples of a cause of an increase in the internal pressure include generation of a gas due to a decomposition reaction of an electrolytic solution upon charging and discharging. Examples of a factor accelerating the decomposition reaction of the electrolytic solution include an internal short circuit in the secondary battery, heating of the secondary battery, and discharging of the secondary battery under a large current condition.

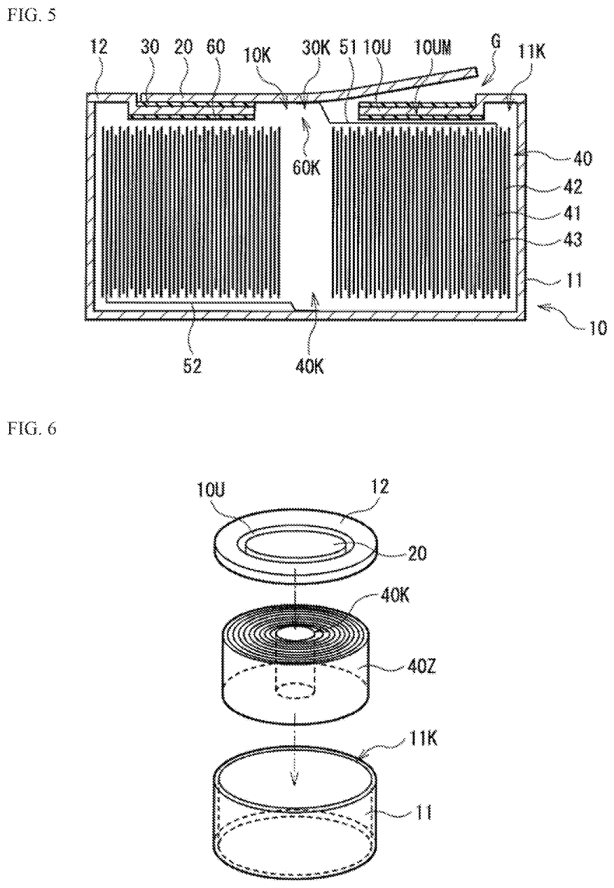

An operation of the external terminal 20 serving as the release valve will be described in detail later (see FIG. 5).

The gasket 30 is an insulating sealing member disposed between the outer package can 10 and the external terminal 20, as illustrated in FIG. 2. Here, the gasket 30 is disposed between the cover part 12 and the external terminal 20, and has a through hole 30K located to overlap the through hole 10K. The gasket 30 is thus so disposed as not to close the through hole 10K.

The gasket 30 includes any one or more of polymer compounds having an insulating property and a hot melt property, and the external terminal 20 is thus thermally welded to the cover part 12 with the gasket 30 interposed between the external terminal 20 and the cover part 12, as described above. The polymer compound is not particularly limited in kind, and specific examples thereof include polypropylene and polyethylene.

A region of placement of the gasket 30 is not particularly limited and may be chosen as desired. Here, the gasket 30 is disposed between a top surface of the cover part 12 and a bottom surface of the external terminal 20 inside the recessed part 10U. Note that the region of placement of the gasket 30 may be extended to a region on an outer side of a region between the top surface of the cover part 12 and the bottom surface of the external terminal 20.

In other words, an inner diameter of the through hole 30K may be the same as or different from the inner diameter of the through hole 10K. FIG. 2 illustrates a case where the inner diameter of the through hole 30K and the inner diameter of the through hole 10K are the same as each other.

The battery device 40 is a power generation device that causes charging and discharging reactions to proceed, and is contained inside the outer package can 10, as illustrated in FIGS. 1 to 4. The battery device 40 includes the positive electrode 41 as a first electrode, the negative electrode 42 as a second electrode, the separator 43, and the electrolytic solution. The electrolytic solution is a liquid electrolyte, and is not illustrated.

Here, the battery device 40 is what is called a wound electrode body. The battery device 40 therefore has a device structure of what is called a wound type. In this case, the positive electrode 41 and the negative electrode 42 are stacked on each other with the separator 43 interposed between the positive electrode 41 and the negative electrode 42, and the stack of the positive electrode 41, the negative electrode 42, and the separator 43 is wound. Thus, the positive electrode 41 and the negative electrode 42 are opposed to each other with the separator 43 interposed between the positive electrode 41 and the negative electrode 42, and are wound. As a result, the battery device 40 has the winding center space 40K that is a winding core part. An extending direction (a vertical direction) of the winding center space 40K is coincident with a passing-through direction (a vertical direction) of the through hole 10K. As a result, a winding direction (a horizontal direction) of the positive electrode 41, the negative electrode 42, and the separator 43 to intersect the passing-through direction of the through hole 10K.

The battery device 40 has a three-dimensional shape similar to the three-dimensional shape of the outer package can 10, and thus has a flat and circular columnar three-dimensional shape. A reason for this is to prevent a dead space, that is, a surplus space between the outer package can 10 and the battery device 40, from easily resulting when the battery device 40 is placed inside the outer package can 10, and to thereby allow for efficient use of the internal space of the outer package can 10, as compared with a case where the battery device 40 has a three-dimensional shape different from the three-dimensional shape of the outer package can 10. As a result, the device space volume increases, and the volumetric energy density increases accordingly.

As illustrated in FIGS. 2 and 3, the positive electrode 41 includes a positive electrode current collector 41A and a positive electrode active material layer 41B.

The positive electrode current collector 41A is an electrically conductive support that supports the positive electrode active material layer 41B. The positive electrode current collector 41A has two opposed surfaces on each of which the positive electrode active material layer 41B is to be provided. The positive electrode current collector 41A includes an electrically conductive material such as a metal material. Specific examples of the electrically conductive material include aluminum.

Here, the positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A, on a side where the positive electrode 41 is opposed to the negative electrode 42. The positive electrode active material layer 41B may further include any one or more of other materials including, without limitation, a positive electrode binder and a positive electrode conductor. A method of forming the positive electrode active material layer 41B is not particularly limited, and specific examples thereof include a coating method.

The positive electrode active material includes a lithium-containing compound. A reason for this is that a high energy density is obtainable. The lithium-containing compound is a compound that includes lithium as a constituent element, and more specifically, a compound that includes lithium and one or more transition metal elements as constituent elements. Note that the lithium-containing compound may further include any one or more of other elements, i.e., elements other than lithium and transition metal elements.

Although not particularly limited in kind, the lithium-containing compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Specific examples of the synthetic rubber include a styrene-butadiene-based rubber. Specific examples of the polymer compound include polyvinylidene difluoride.

The positive electrode conductor includes any one or more of electrically conductive materials including, without limitation, a carbon material. Specific examples of the electrically conductive materials include graphite, carbon black, acetylene black, and Ketjen black. Note that the electrically conductive material may be a metal material or a polymer compound, for example.

As illustrated in FIGS. 2 and 3, the negative electrode 42 includes a negative electrode current collector 42A and a negative electrode active material layer 42B.

The negative electrode current collector 42A is an electrically conductive support that supports the negative electrode active material layer 42B. The negative electrode current collector 42A has two opposed surfaces on each of which the negative electrode active material layer 42B is to be provided. The negative electrode current collector 42A includes an electrically conductive material such as a metal material. Specific examples of the electrically conductive material include copper.

Here, the negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A, on a side where the negative electrode 42 is opposed to the positive electrode 41. The negative electrode active material layer 42B may further include any one or more of other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes any one or more of materials including, without limitation, a carbon material and a metal-based material. A reason for this is that a high energy density is obtainable. Specific examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Specific examples of such metal elements and metalloid elements include silicon and tin. Note that the metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

The separator 43 is an insulating porous film interposed between the positive electrode 41 and the negative electrode 42, as illustrated in FIGS. 2 and 3. The separator 43 prevents a short circuit between the positive electrode 41 and the negative electrode 42 and allows lithium ions to pass therethrough. The separator 43 includes a polymer compound such as polyethylene.

The electrolytic solution includes a solvent and an electrolyte salt. The positive electrode 41, the negative electrode 42, and the separator 43 are each impregnated with the electrolytic solution.

Here, the solvent includes any one or more of non-aqueous solvents (organic solvents). An electrolytic solution that includes the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is a cyclic carbonic acid ester or a chain carbonic acid ester, for example. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include methyl acetate, ethyl acetate, methyl propionate, ethyl propionate, propyl propionate, ethyl trimethylacetate, methyl butyrate, and ethyl butyrate.

The lactone-based compound is a lactone, for example. Specific examples of the lactone include y-butyrolactone and γ-valerolactone.

Note that the ether may be the lactone-based compound described above, 1,2-dimethoxyethane, tetrahydrofuran, 1,3-dioxolane, or 1,4-dioxane, for example.

The electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl) imide (LiN(FSO₂)₂), lithium bis(trifluoromethanesulfonyl) imide (LiN(CF₃SO₂)₂), lithium tris(trifluoromethanesulfonyl) methide (LiC(CF₃SO₂)₃), lithium bis(oxalato) borate (LiB(C₂O₄)₂), and lithium difluoro (oxalato) borate (LiB(C₂O₄)F₂).

A content of the electrolyte salt is not particularly limited, and is specifically within a range from 0.3 mol/kg to 3.0 mol/kg both inclusive with respect to the solvent. A reason for this is that high ion conductivity is obtainable.

The positive electrode lead 51 is a wiring member for electrically coupling the positive electrode 41 to the external terminal 20, and is contained inside the outer package can 10, as illustrated in FIG. 2. The positive electrode lead 51 is coupled to the external terminal 20 through the through hole 10K, and is also coupled to the positive electrode current collector 41A of the positive electrode 41. The positive electrode lead 51 is thus electrically coupled to each of the external terminal 20 and the positive electrode 41. Here, the positive electrode lead 51 is coupled to the positive electrode 41 on a side close to the cover part 12, and is thus coupled to an upper end part of the positive electrode 41.

Note that the secondary battery includes one positive electrode lead 51, but may include two or more positive electrode leads 51. A reason for this is that an increase in the number of the positive electrode leads 51 results in a decrease in electrical resistance of the battery device 40.

Details of a material included in the positive electrode lead 51 are similar to the details of the material included in the positive electrode current collector 41A. Note that the material included in the positive electrode lead 51 and the material included in the positive electrode current collector 41A may be the same or different from each other.

The positive electrode lead 51 is a member that is physically separate from the positive electrode current collector 41A and is thus provided separately from the positive electrode current collector 41A. Alternatively, the positive electrode lead 51 may be a member that is physically continuous with the positive electrode current collector 41A and is thus provided integrally with the positive electrode current collector 41A.

The negative electrode lead 52 is a member for electrically coupling the negative electrode 42 to the outer package can 10, and is contained inside the outer package can 10, as illustrated in FIG. 2. The negative electrode lead 52 is coupled to the container part 11 (the lower bottom part M2), and is also coupled to the negative electrode current collector 42A of the negative electrode 42. The negative electrode lead 52 is thus electrically coupled to each of the outer package can 10 and the negative electrode 42. Here, the negative electrode lead 52 is coupled to the negative electrode 42 on a side away from the cover part 12, and is thus coupled to a lower end part of the negative electrode 42.

Note that the secondary battery includes one negative electrode lead 52, but may include two or more negative electrode leads 52. A reason for this is that an increase in the number of the negative electrode leads 52 results in a decrease in electrical resistance of the battery device 40.

Details of a material included in the negative electrode lead 52 are similar to the details of the material included in the negative electrode current collector 42A. Note that the material included in the negative electrode lead 52 and the material included in the negative electrode current collector 42A may be the same or different from each other.

The negative electrode lead 52 is a member that is physically separate from the negative electrode current collector 42A and is thus provided separately from the negative electrode current collector 42A. Alternatively, the negative electrode lead 52 may be a member that is physically continuous with the negative electrode current collector 42A and is thus provided integrally with the negative electrode current collector 42A.

As illustrated in FIGS. 2 and 4, the insulating film 60 is an insulating member disposed between the outer package can 10 and the battery device 40. Here, the insulating film 60 is disposed between the cover part 12 and the battery device 40, and has a through hole 60K located to overlap the through hole 10K. The insulating film 60 is thus so disposed as not to block the through hole 10K.

An inner diameter of the through hole 60K may be the same as or different from the inner diameter of the through hole 10K. FIG. 2 illustrates a case where the inner diameter of the through hole 60K and the inner diameter of the through hole 10K are the same as each other.

The insulating film 60 covers the opposed surface 10UM, and is fixed to the opposed surface 10UM. In FIG. 4, for easy understanding of a range of placement of the insulating film 60, the insulating film 60 is darkly shaded.

The secondary battery includes the insulating film 60, and the insulating film 60 covers the opposed surface 10UM and is fixed to the opposed surface 10UM. A reason for this is to prevent a short circuit from occurring even if a portion (the recessed part 10U) of the outer package can 10 (the cover part 12) protrudes toward the battery device 40.

To be more specific, when the portion of the outer package can 10 protrudes toward the battery device 40 to cause the opposed surface 10UM to be closer to the battery device 40, the battery device 40 (the positive electrode 41) and the outer package can 10 (the external coupling terminal of the negative electrode 42) are brought closer to each other. This results in easy occurrence of contact (a short circuit) between the positive electrode 41 and the outer package can 10, which makes it difficult for the secondary battery to operate stably.

Further, when the insulating film 60 does not cover the opposed surface 10UM even if the insulating film 60 is present between the battery device 40 and the outer package can 10, the positive electrode 41 and the outer package can 10 can come into contact with each other in a portion (a region in which the insulating film 60 is absent) of the opposed surface 10UM. This also causes easy occurrence of a short circuit, which makes it difficult for the secondary battery to operate stably.

In addition, when the insulating film 60 is not fixed to the opposed surface 10UM even if the insulating film 60 covers the opposed surface 10UM, the insulating film 60 is easily displaced if the secondary battery undergoes vibration or impact, for example. Accordingly, the positive electrode 41 and the outer package can 10 can come into contact with each other in a portion of the opposed surface 10UM. This also causes easy occurrence of a short circuit, which makes it difficult for the secondary battery to operate stably.

In contrast, when the insulating film 60 is present between the battery device 40 and the outer package can 10, and the insulating film 60 covers the opposed surface 10UM and is fixed to the opposed surface 10UM, the positive electrode 41 and the outer package can 10 are prevented from easily coming into contact with each other over a whole of the opposed surface 10UM, and the insulating film 60 is prevented from being easily displaced even if the secondary battery undergoes vibration or impact, for example. This prevents easy occurrence of a short circuit, and thus makes it easier for the secondary battery to operate stably.

Note that, as will be described later, fixing the insulating film 60 to the opposed surface 10UM prevents the insulating film 60 from becoming an obstacle when the electrolytic solution is injected into the container part 11, in which a wound body 40Z is contained, in a process of manufacturing the secondary battery. This also provides an advantage in that it becomes easier for the wound body 40Z to be impregnated with the electrolytic solution (see FIG. 6). A description will be given later in detail as to the reason described here.

The insulating film 60 includes any one or more of insulating materials including, without limitation, an insulating polymer compound. Specific examples of the insulating materials include polyimide.

Note that the insulating film 60 may be a non-adhesive member that does not include an adhesive layer, or may be an adhesive member (what is called an adhesive tape) including the adhesive layer that is unillustrated. The insulating film 60 having a non-adhesion property is adhered to the opposed surface 10UM by an adhesive, and is thus fixed to the opposed surface 10UM. The insulating film 60 having an adhesion property is adhered to the opposed surface 10UM by the adhesive layer, and is thus fixed to the opposed surface 10UM.

The insulating film 60 is fixed to the opposed surface 10UM. Accordingly, the insulating film 60 is disposed between the cover part 12 and the positive electrode lead 51, and a portion of the positive electrode lead 51 is disposed between the insulating film 60 and the battery device 40.

Note that the secondary battery may further include any one or more of other components that are unillustrated.

An example of the other components include a sealant. The sealant is an insulating covering member that covers a surface of the positive electrode lead 51. The positive electrode lead 51 is insulated from each of the outer package can 10 and the negative electrode 42 by the sealant. Note that the sealant includes any one or more of insulating materials including, without limitation, an insulating polymer compound. Specific examples of the insulating materials include polyimide.

Examples of the other components further include another insulating film. The other insulating film is an insulating member disposed between the container part 11 (the lower bottom part M2) and the battery device 40. A material included in the other insulating film is similar to the material included in the insulating film 60.

FIG. 5 illustrates a sectional configuration corresponding to FIG. 2 to describe operations of the secondary battery. In the following, a description is given first of an operation at the time of charging and discharging, and thereafter of an operation at the time of occurrence of an abnormal condition.

Upon charging, in the battery device 40, lithium is extracted from the positive electrode 41, and the extracted lithium is inserted into the negative electrode 42 via the electrolytic solution. Upon discharging, in the battery device 40, lithium is extracted from the negative electrode 42, and the extracted lithium is inserted into the positive electrode 41 via the electrolytic solution. Upon the charging and the discharging, lithium is inserted and extracted in an ionic state.

As described above, the external terminal 20 is disposed on the outer side of the cover part 12 and is fixed to the cover part 12 with the gasket 30 interposed between the external terminal 20 and the cover part 12. Accordingly, under normal conditions, the outer package can 10 is sealed by the external terminal 20. As a result, the battery device 40 is sealed in the outer package can 10.

In contrast, upon the occurrence of an abnormal condition, that is, upon an excessive increase in the internal pressure of the outer package can 10, the external terminal 20 is pushed outward (upward) through the through hole 10K due to the increased internal pressure. In this case, if a strength of a force pushing the external terminal 20 outward becomes higher than a fixation strength (what is called a seal strength) by which the external terminal 20 is fixed to the cover part 12 with the gasket 30 interposed between the external terminal 20 and the cover part 12, the external terminal 20 becomes separated partially or entirely from the cover part 12.

This forms, as illustrated in FIG. 5, a gap G (a release path of the internal pressure) between the cover part 12 and the external terminal 20, allowing the internal pressure to be released through the gap G. FIG. 5 illustrates a case where the external terminal 20 has become separated partially from the cover part 12.

As described above, the container part 11 is joined to the cover part 12, whereas the external terminal 20 is fixed to the cover part 12 with the gasket 30 interposed between the external terminal 20 and the cover part 12. Accordingly, the fixation strength (a thermal welding strength) of the external terminal 20 to the cover part 12 is lower than a joining strength (a welding strength) of the cover part 12 to the container part 11. In this case, if the internal pressure of the outer package can 10 excessively increases, the external terminal 20 becomes separated from the cover part 12 before the cover part 12 becomes separated from the container part 11. In this way, the external terminal 20 operates as a release valve before the outer package can 10 ruptures. A rupture of the outer package can 10 is thereby prevented.

FIG. 6 illustrates a perspective configuration corresponding to FIG. 1 to describe the process of manufacturing the secondary battery. Note that FIG. 6 illustrates a state before joining the cover part 12 to the container part 11. The cover part 12 is thus separate from the container part 11 in FIG. 6.

When manufacturing the secondary battery, in accordance with an example procedure described below, the positive electrode 41 and the negative electrode 42 are fabricated and the electrolytic solution is prepared, following which the secondary battery is assembled using the positive electrode 41, the negative electrode 42, and the electrolytic solution, and the secondary battery after being assembled is subjected to a stabilization process. In the following description, where appropriate, FIGS. 1 to 4 described already above will be referenced in addition to FIG. 6.

Here, as illustrated in FIG. 6, the container part 11 and the cover part 12 that are physically separate from each other are used to form the outer package can 10. As described above, the container part 11 has the opening 11K, and the cover part 12 includes the recessed part 10U. Further, as described above, the external terminal 20 is thermally welded to the cover part 12 in advance, with the gasket 30 interposed between the external terminal 20 and the cover part 12, and the insulating film 60 that is the adhesive tape is adhered to the cover part 12 in advance.

First, a positive electrode mixture that is a mixture of the positive electrode active material, the positive electrode binder, and the positive electrode conductor is put into a solvent to thereby prepare a positive electrode mixture slurry in paste form. The solvent may be an aqueous solvent or an organic solvent. The details of the solvent described here apply also to the description below. Thereafter, the positive electrode mixture slurry is applied on the two opposed surfaces of the positive electrode current collector 41A to thereby form the positive electrode active material layers 41B. Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the respective positive electrode active material layers 41B are formed on the two opposed surfaces of the positive electrode current collector 41A. The positive electrode 41 is thus fabricated.

First, a negative electrode mixture that is a mixture of the negative electrode active material, the negative electrode binder, and the negative electrode conductor is put into a solvent to thereby prepare a negative electrode mixture slurry in paste form. Thereafter, the negative electrode mixture slurry is applied on the two opposed surfaces of the negative electrode current collector 42A to thereby form the negative electrode active material layers 42B. Lastly, the negative electrode active material layers 42B are compression-molded by means of, for example, a roll pressing machine. Details of the compression molding of the negative electrode active material layers 42B are similar to the details of the compression molding of the positive electrode active material layers 41B. In this manner, the respective negative electrode active material layers 42B are formed on the two opposed surfaces of the negative electrode current collector 42A. The negative electrode 42 is thus fabricated.

The electrolyte salt is put into the solvent. The electrolyte salt is thereby dispersed or dissolved in the solvent. The electrolytic solution is thus prepared.

First, the positive electrode lead 51 is coupled to the positive electrode current collector 41A of the positive electrode 41 by means of, for example, a welding method, and the negative electrode lead 52 is coupled to the negative electrode current collector 42A of the negative electrode 42 by means of, for example, a welding method.

Thereafter, the positive electrode 41 and the negative electrode 42 are stacked with the separator 43 interposed between the positive electrode 41 and the negative electrode 42, following which the stack of the positive electrode 41, the negative electrode 42, and the separator 43 is wound. The wound body 40Z having the winding center space 40K is thereby fabricated as illustrated in FIG. 6. The wound body 40Z has a configuration similar to the configuration of the battery device 40 except that the positive electrode 41, the negative electrode 42, and the separator 43 are each unimpregnated with the electrolytic solution. FIG. 6 omits the illustration of each of the positive electrode lead 51 and the negative electrode lead 52.

Thereafter, the wound body 40Z is placed into the container part 11 through the opening 11K. In this case, the negative electrode lead 52 is coupled to the container part 11 by means of, for example, a welding method.

Thereafter, with use of the cover part 12 on which the external terminal 20 and the insulating film 60 are provided in advance, the positive electrode lead 51 is coupled to the external terminal 20 through the through hole 10K by means of, for example, a welding method.

Thereafter, the electrolytic solution is injected into the container part 11 through the opening 11K. The wound body 40Z (including the positive electrode 41, the negative electrode 42, and the separator 43) is thereby impregnated with the electrolytic solution. Thus, the battery device 40 that is the wound electrode body is fabricated.

In this case, as described above, the insulating film 60 is fixed to the cover part 12, and this prevents the insulating film 60 from becoming an obstacle when the electrolytic solution is injected into the container part 11, unlike in a case where the insulating film 60 is adhered to the battery device 40. Accordingly, it becomes easier to inject the electrolytic solution into the container part 11. This makes it easier for the wound body 40Z to be impregnated with the electrolytic solution.

In particular, when the electrolytic solution is injected into the container part 11, the electrolytic solution is partly supplied into the winding center space 40K. The winding center space 40K is thus used as an impregnation path of the electrolytic solution. This makes it easier for the wound body 40Z to be impregnated with the electrolytic solution.

Thereafter, the opening 11K is blocked with the cover part 12, following which the cover part 12 is joined to the container part 11 by means of a joining method such as a welding method. This forms the outer package can 10 and allows the battery device 40 to be contained inside the outer package can 10. The secondary battery is thus assembled, as illustrated in FIG. 2.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of each of the positive electrode 41 and the negative electrode 42 in the battery device 40. This brings the secondary battery into an electrochemically stable state.

As a result, the battery device 40 and other components are sealed in the outer package can 10. Thus, the secondary battery is completed.

According to the secondary battery, the battery device 40 is contained inside the outer package can 10 having an electrically conductive property and having the through hole 10K. The external terminal 20 disposed on the outer side of the outer package can 10 blocks the through hole 10K. The gasket 30 having an insulating property is disposed between the outer package can 10 and the external terminal 20. Further, the recessed part 10U having the through hole 10K is provided in the outer package can 10. The insulating film 60 that is disposed between the outer package can 10 and the battery device 40 covers the opposed surface 10UM of the recessed part 10U, and is fixed to the opposed surface 10UM. Accordingly, for reasons described below, it is possible to achieve both a superior capacity characteristic and superior operational stability.

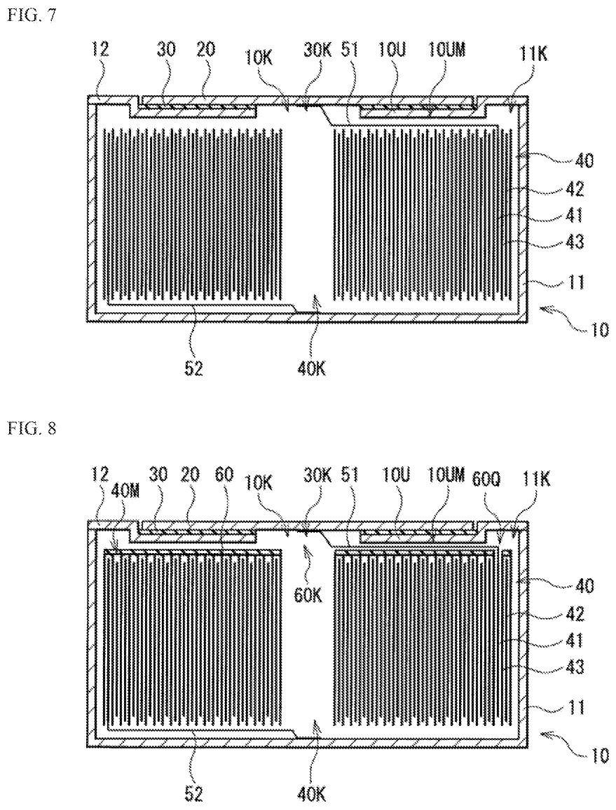

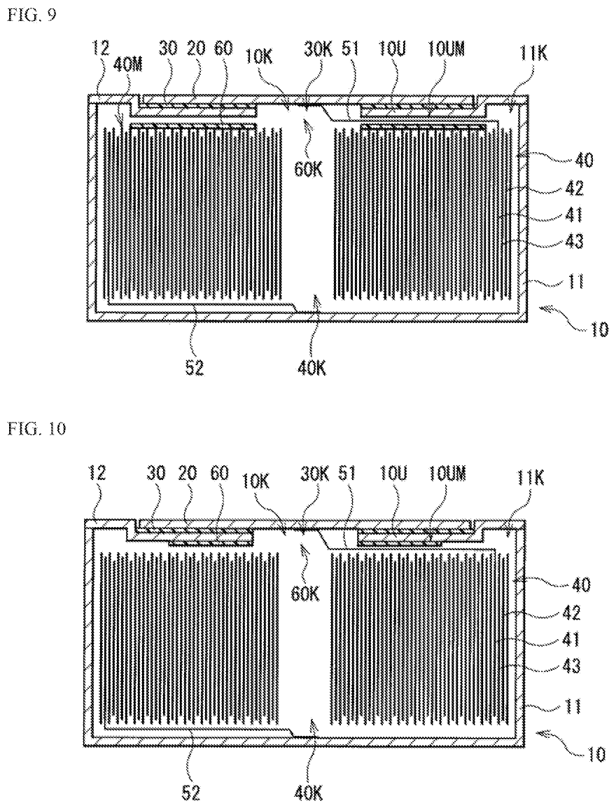

FIG. 7 illustrates a sectional configuration of a secondary battery of Comparative example 1, and corresponds to FIG. 2. FIG. 8 illustrates a sectional configuration of a secondary battery of Comparative example 2, and corresponds to FIG. 2. FIG. 9 illustrates a sectional configuration of a secondary battery of Comparative example 3, and corresponds to FIG. 2. FIG. 10 illustrates a sectional configuration of a secondary battery of Comparative example 4, and corresponds to FIG. 2. FIG. 11 illustrates a planar configuration of a main part of the secondary battery illustrated in FIG. 10, and corresponds to FIG. 4.

As illustrated in FIG. 7, the secondary battery of Comparative example 1 has a configuration similar to the configuration of the secondary battery (FIG. 2) of the present embodiment, except that no insulating film 60 is included.

As illustrated in FIGS. 8 and 9, the secondary battery of each of Comparative examples 2 and 3 has a configuration similar to the configuration of the secondary battery (FIG. 2) of the present embodiment except that although the secondary battery includes the insulating film 60, the insulating film 60 is fixed to the battery device 40. Note that, in the secondary battery of Comparative example 2, the insulating film 60 covers a whole of an upper end face 40M of the battery device 40, and is provided with a leading-out hole 60Q that allows the positive electrode lead 51 to be led out. In the secondary battery of Comparative example 3, the insulating film 60 covers only a portion of the upper end face 40M.

As illustrated in FIGS. 10 and 11, the secondary battery of Comparative example 4 has a configuration similar to the configuration of the secondary battery (FIGS. 2 and 4) of the present embodiment except that although the secondary battery includes the insulating film 60, the insulating film 60 covers only a portion of the opposed surface 10UM. In FIG. 11, the opposed surface 10UM is lightly shaded.

In the secondary battery of Comparative example 1, as illustrated in FIG. 7, no insulating film 60 is interposed between the outer package can 10 and the battery device 40. In this case, the insulating film 60 is absent that becomes an obstacle when the electrolytic solution is injected into the container part 11 through the opening 11K in the process of manufacturing the secondary battery. Accordingly, a process of injecting the electrolytic solution is not hampered by the insulating film 60, which makes it easier for the wound body 40Z to be impregnated with the electrolytic solution. This increases an amount of the electrolytic solution retained by the battery device 40, and thus secures the battery capacity.

However, a portion (the recessed part 10U) of the outer package can 10 protrudes toward the battery device 40. This brings the opposed surface 10UM closer to the battery device 40, and the battery device 40 (the positive electrode 41) and the outer package can 10 (the external coupling terminal of the negative electrode 42) are thus brought closer to each other. As a result, contact (a short circuit) between the positive electrode 41 and the outer package can 10 easily occurs, which makes it difficult for the secondary battery to operate stably.

For these reasons, in the secondary battery of Comparative example 1, the battery capacity is secured, but it is difficult for the secondary battery to operate stably. Accordingly, it is difficult to achieve both a superior capacity characteristic and superior operational stability.

In the secondary battery of Comparative example 2, as illustrated in FIG. 8, the portion of the outer package can 10 protrudes toward the battery device 40, and the opposed surface 10UM is thus brought closer to the battery device 40; however, the insulating film 60 is interposed between the battery device 40 and the outer package can 10, and the insulating film 60 covers the whole of the upper end face 40M. This prevents easy occurrence of a short circuit between the positive electrode 41 and the outer package can 10, and thus makes it easier for the secondary battery to operate stably.

However, because the insulating film 60 covers the whole of the upper end face 40M, the insulating film 60 becomes an obstacle when the electrolytic solution is injected into the container part 11 through the opening 11K in the process of manufacturing the secondary battery. Accordingly, the process of injecting the electrolytic solution is hampered by the insulating film 60, which makes it difficult for the wound body 40Z to be impregnated with the electrolytic solution. This decreases the amount of the electrolytic solution retained by the battery device 40, and thus decreases the battery capacity.

For these reasons, the secondary battery of Comparative example 2 suffers a decrease in the battery capacity, although it is easier for the secondary battery to operate stably. Accordingly, it is difficult to achieve both a superior capacity characteristic and superior operational stability.

In the secondary battery of Comparative example 3, as illustrated in FIG. 9, the opposed surface 10UM is close to the battery device 40; however, the insulating film 60 is interposed between the battery device 40 and the outer package can 10, and the insulating film 60 covers only a portion of the upper end face 40M. This allows a location to remain where the insulating film 60 is absent that becomes an obstacle when the electrolytic solution is injected into the container part 11 through the opening 11K in the process of manufacturing the secondary battery. This prevents the process of injecting the electrolytic solution from being hampered by the insulating film 60, and thus makes it easier for the wound body 40Z to be impregnated with the electrolytic solution in the location where the insulating film 60 is absent. This increases the amount of the electrolytic solution retained by the battery device 40, and thus increases the battery capacity.

In this case, in particular, it becomes easier for the wound body 40Z to be impregnated with the electrolytic solution in the location where the insulating film 60 is absent; however, it becomes difficult for the wound body 40Z to be impregnated with the electrolytic solution in a location where the insulating film 60 is present. Accordingly, although the battery capacity increases as compared with the secondary battery of Comparative example 2, the increase in the battery capacity is not sufficient.

In the location where the insulating film 60 is absent, however, a portion of the battery device 40 is exposed. This brings the opposed surface 10UM closer to the battery device 40, and the battery device 40 and the outer package can 10 are thus brought closer to each other. As a result, a short circuit between the positive electrode 41 and the outer package can 10 easily occurs, which makes it difficult for the secondary battery to operate stably.

In this case, in particular, if the battery device 40 is displaced inside the outer package can 10 when the secondary battery undergoes vibration or impact, for example, the insulating film 60 that is fixed to the battery device 40 is also easily displaced. This results in easy occurrence of a short circuit between the positive electrode 41 and the outer package can 10 as compared with the secondary battery of Comparative example 2.

For these reasons, in the secondary battery of Comparative example 3, it is difficult to sufficiently increase the battery capacity, and it is not easier for the secondary battery to operate sufficiently stably. Accordingly, it is difficult to achieve both a superior capacity characteristic and superior operational stability.

In the secondary battery of Comparative example 4, as illustrated in FIGS. 10 and 11, the insulating film 60 is fixed to the opposed surface 10UM, and this prevents the insulating film 60 from becoming an obstacle when the electrolytic solution is injected into the container part 11 through the opening 11K in the process of manufacturing the secondary battery. For the reasons described above, this increases an amount of the electrolytic solution retained by the battery device 40 and thus secures the battery capacity.

Further, the insulating film 60 is interposed between the battery device 40 and the outer package can 10, and this prevents easy occurrence of a short circuit between the positive electrode 41 and the outer package can 10 in the location where the insulating film 60 is present.

However, the insulating film 60 covers only a portion of the opposed surface 10UM. Thus, in the location where the insulating film 60 is absent, a short circuit between the positive electrode 41 and the outer package can 10 easily occurs.

For these reasons, in the secondary battery of Comparative example 4, the battery capacity is secured, but it is still difficult for the secondary battery to operate stably. Accordingly, it is difficult to achieve both a superior capacity characteristic and superior operational stability.

In contrast, in the secondary battery of the present embodiment, the insulating film 60 is fixed to the opposed surface 10UM as illustrated in FIGS. 2 and 4, and as a result, the battery capacity is secured for the reasons described above.

Further, the insulating film 60 is interposed between the battery device 40 and the outer package can 10, and the insulating film 60 covers the whole of the opposed surface 10UM. This prevents easy occurrence of a short circuit between the positive electrode 41 and the outer package can 10 over the whole of the opposed surface 10UM, and thus makes it easier for the secondary battery to operate stably.

In this case, in particular, the insulating film 60 is prevented from being easily displaced even if the battery device 40 is displaced inside the outer package can 10 when the secondary battery undergoes vibration or impact, for example. This prevents easy occurrence of a short circuit between the positive electrode 41 and the outer package can 10, and thus makes it easier for the secondary battery to operate stably and continuously.

For these reasons, in the secondary battery of the present embodiment, the battery capacity is secured, and it is easier for the secondary battery to operate stably. Accordingly, it is possible to achieve both a superior capacity characteristic and superior operational stability.

In particular, in the secondary battery of the present embodiment, the external terminal 20 may be contained inside the recessed part 10U. This increases the volumetric energy density. Accordingly, the battery capacity further increases, which makes it possible to achieve higher effects.

Further, the outer package can 10 may include the container part 11 and the cover part 12, and the container part 11 and the cover part 12 may be joined to each other. In such a case, the secondary battery is configured using the outer package can 10 that is what is called a crimpless joined can. Accordingly, the volumetric energy density further increases. This further improves a capacity characteristic, which makes it possible to achieve higher effects.

Further, the positive electrode 41 may be electrically coupled to the external terminal 20, and the negative electrode 42 may be electrically coupled to the outer package can 10. This allows the external terminal 20 to operate as the external coupling terminal of the positive electrode 41, and allows the outer package can 10 to operate as the external coupling terminal of the negative electrode 42. It is thus unnecessary for the secondary battery to be provided with an external coupling terminal of the positive electrode 41 and an external coupling terminal of the negative electrode 42 separate from the outer package can 10 and the external terminal 20. As a result, the volumetric energy density further increases. Accordingly, the capacity characteristic further improves, which makes it possible to achieve higher effects.

Further, the outer package can 10 may have a flat and columnar three-dimensional shape. This makes it possible to achieve a superior capacity characteristic and superior operational stability even in a small-sized secondary battery in which the internal pressure of the outer package can 10 easily increases. Accordingly, it is possible to achieve higher effects.

Further, the outer package can 10 may include a metal can. In such a case, deformation of the outer package can 10 is suppressed. Accordingly, it becomes easier for the secondary battery to operate stably in terms of physical durability of the outer package can 10, which makes it possible to achieve higher effects.

Further, the secondary battery may include a lithium-ion secondary battery. In such a case, a sufficient battery capacity is stably obtainable through the use of insertion and extraction of lithium. Accordingly, it is possible to achieve higher effects.

The configuration of the secondary battery is appropriately modifiable, including as described below, according to an embodiment. Note that any two or more of the following series of modifications may be combined with each other.

In FIGS. 2 and 4, the insulating film 60 covers the opposed surface 10UM. However, the insulating film 60 simply has to cover the opposed surface 10UM. Thus, a region of placement of the insulating film 60 may be extended beyond the opposed surface 10UM.

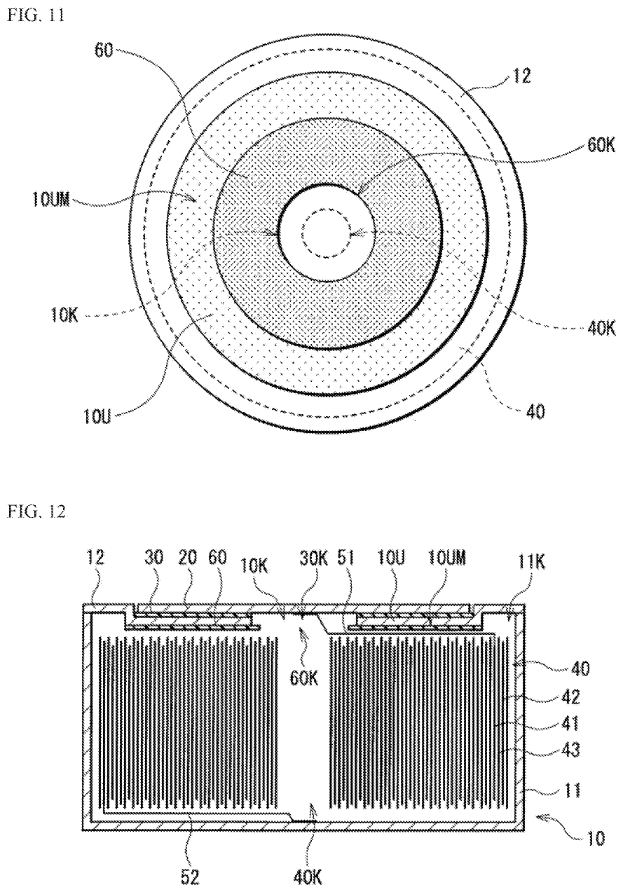

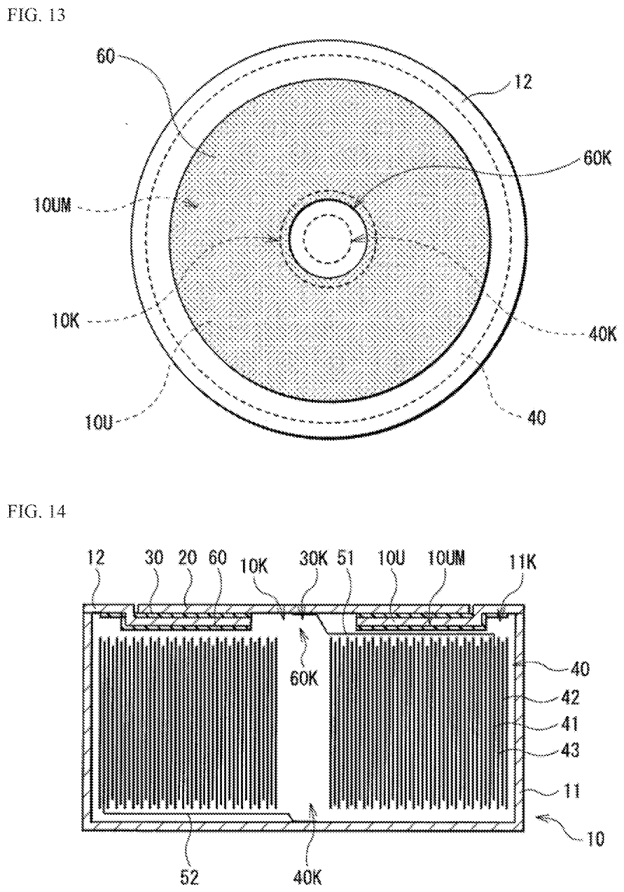

As illustrated in FIG. 12 corresponding to FIG. 2 and FIG. 13 corresponding to FIG. 4, the region of placement of the insulating film 60 may be extended to an inner side relative to the opposed surface 10UM. However, in order to ensure a coupling path of the positive electrode lead 51 to the external terminal 20, the insulating film 60 is so disposed as not to close the through hole 10K.

In this case also, the insulating film 60 helps to secure the battery capacity and to make it easier for the secondary battery to operate stably. Accordingly, it is possible to achieve similar effects. In this case, in particular, a portion of the insulating film 60 extended to the inner side helps to prevent contact between the positive electrode lead 51 and the outer package can 10 (the cover part 12). Accordingly, it is possible to achieve higher effects.

Further, as illustrated in FIGS. 14 and 15 respectively corresponding to FIGS. 2 and 4, the region of placement of the insulating film 60 may be extended to an outer side relative to the opposed surface 10UM. A position of an outer edge of the insulating film 60 is not particularly limited and may be chosen as desired.

In this case also, the insulating film 60 helps to secure the battery capacity and to make it easier for the secondary battery to operate stably. Accordingly, it is possible to achieve similar effects. In this case, in particular, a portion of the insulating film 60 extended to the outer side helps to make it easier to prevent contact between the positive electrode 41 and the outer package can 10 (the cover part 12) even when the secondary battery accidentally deforms due to an impact caused by a drop, for example. Accordingly, it is possible to achieve higher effects.

It should be noted, however, that although not specifically illustrated here, if the insulating film 60 is excessively extended to the outer side relative to the opposed surface 10UM, it can become difficult to stably form the outer package can 10 in the process of manufacturing the secondary battery.

If the region of placement of the insulating film 60 is excessively extended to the outer side, it becomes easier for a portion of the insulating film 60 to become interposed between the container part 11 and the cover part 12 upon joining of the cover part 12 to the container part 11. This hampers easy joining of the cover part 12 to the container part 11, which can make it difficult to stably form the outer package can 10.

In contrast, if the region of placement of the insulating film 60 is extended appropriately, a portion of the insulating film 60 is prevented from easily becoming interposed between the container part 11 and the cover part 12. This allows for easy joining of the cover part 12 to the container part 11, which makes it easier to stably form the outer package can 10.

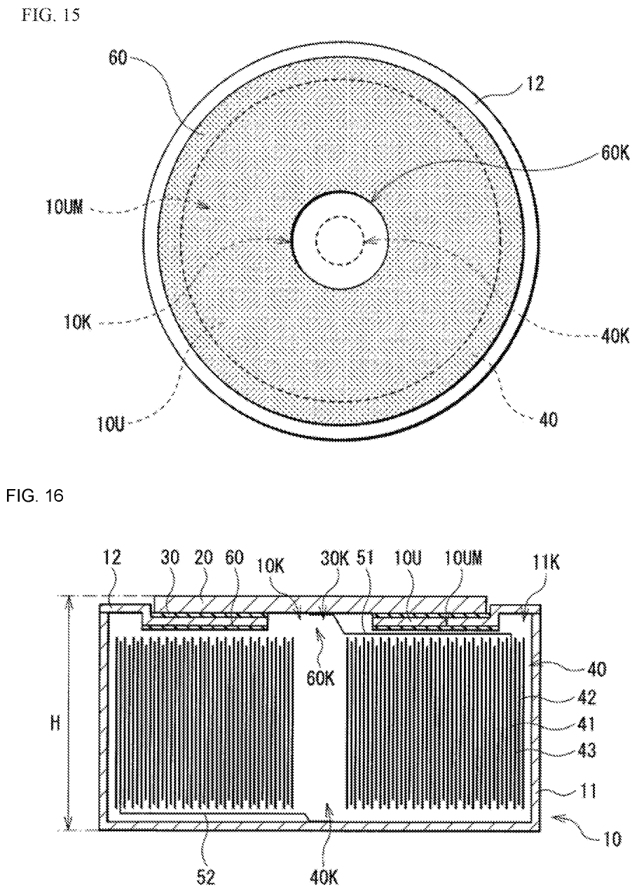

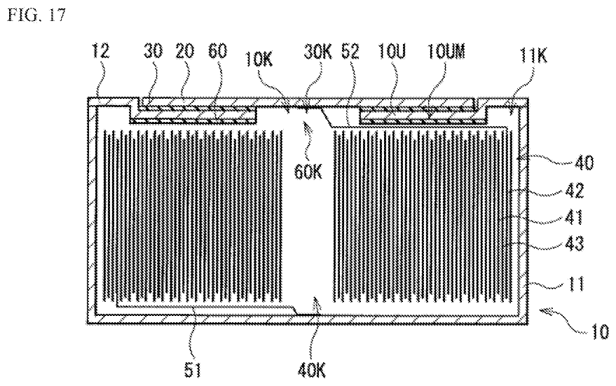

In FIG. 2, the external terminal 20 is contained inside the recessed part 10U, and thus does not protrude outward from the recessed part 10U. However, as illustrated in FIG. 16 corresponding to FIG. 2, a portion of the external terminal 20 may be contained inside the recessed part 10U and accordingly, the remaining portion of the external terminal 20 may protrude outward from the recessed part 10U.

In this case also, the insulating film 60 helps to secure the battery capacity and to make it easier for the secondary battery to operate stably. Accordingly, it is possible to achieve similar effects. It should be noted, however, that protrusion of the external terminal 20 outward from the recessed part 10U causes the height H to increase, which can decrease the battery capacity due to a decrease in the volumetric energy density.

In FIG. 2, the positive electrode 41 serving as the first electrode is coupled to the external terminal 20 via the positive electrode lead 51, and the negative electrode 42 serving as the second electrode is coupled to the container part 11 via the negative electrode lead 52. Thus, the external terminal 20 serves as the external coupling terminal of the positive electrode 41, and the outer package can 10 serves as the external coupling terminal of the negative electrode 42.

However, as illustrated in FIG. 17 corresponding to FIG. 2, the positive electrode 41 serving as the second electrode may be coupled to the container part 11 via the positive electrode lead 51, and the negative electrode 42 serving as the first electrode may be coupled to the external terminal 20 via the negative electrode lead 52. Thus, the outer package can 10 may serve as the external coupling terminal of the positive electrode 41, and the external terminal 20 may serve as the external coupling terminal of the negative electrode 42.

In this case, to serve as the external coupling terminal of the negative electrode 42, the external terminal 20 includes any one or more of electrically conductive materials including a metal material and an alloy material. Specific examples of the electrically conductive materials include iron, copper, nickel, stainless steel, an iron alloy, a copper alloy, and a nickel alloy. To serve as the external coupling terminal of the positive electrode 41, the outer package can 10, that is, each of the container part 11 and the cover part 12 includes any one or more of electrically conductive materials including a metal material and an alloy material. Specific examples of the electrically conductive materials include aluminum, an aluminum alloy, and stainless steel.

In this case also, the secondary battery is couplable to electronic equipment via the external terminal 20 (the external coupling terminal of the negative electrode 42) and the outer package can 10 (the external coupling terminal of the positive electrode 41). Thus, the insulating film 60 helps to secure the battery capacity, which makes it easier for the secondary battery to operate stably. Accordingly, it is possible to achieve similar effects.

The separator 43 that is a porous film is used. However, although not specifically illustrated here, a separator of a stacked type may be used instead of the separator 43. The separator of the stacked type includes a polymer compound layer.

For example, the separator of the stacked type includes a porous film having two opposed surfaces, and the polymer compound layer provided on one of or each of the two opposed surfaces of the porous film. A reason for this is that adherence of the separator to each of the positive electrode 41 and the negative electrode 42 improves to allow for suppression of winding displacement of the battery device 40. This suppresses swelling of the secondary battery even if a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation of the secondary battery, thus improving safety or heat resistance of the secondary battery. The insulating particles are inorganic particles, resin particles, or both, for example. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

When fabricating the separator of the stacked type, a precursor solution including, without limitation, the polymer compound and a solvent is prepared, following which the precursor solution is applied on one of or each of the two opposed surfaces of the porous film. In this case, instead of applying the precursor solution on the porous film, the porous film may be immersed in the precursor solution. In addition, the insulating particles may be added to the precursor solution.

When the separator of the stacked type is used also, lithium ions are movable between the positive electrode 41 and the negative electrode 42, and similar effects are therefore achievable. In this case, in particular, the safety of the secondary battery improves as described above. Accordingly, it is possible to achieve higher effects.

The electrolytic solution that is a liquid electrolyte is used. However, although not specifically illustrated here, an electrolyte layer that is a gel electrolyte may be used instead of the electrolytic solution.

In the battery device 40 including the electrolyte layer, the positive electrode 41 and the negative electrode 42 are stacked on each other with the separator 43 and the electrolyte layer interposed between the positive electrode 41 and the negative electrode 42, and the stack of the positive electrode 41, the negative electrode 42, the separator 43, and the electrolyte layer is wound. The electrolyte layer is interposed between the positive electrode 41 and the separator 43, and between the negative electrode 42 and the separator 43. Note that the electrolyte layer may be interposed only between the positive electrode 41 and the separator 43, or may be interposed only between the negative electrode 42 and the separator 43.

For example, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. When forming the electrolyte layer, a precursor solution including, for example, the electrolytic solution, the polymer compound, and a solvent is prepared, following which the precursor solution is applied on one of or each of both sides of the positive electrode 41 and on one of or each of both sides of the negative electrode 42.

When the electrolyte layer is used also, similar effects are achievable because lithium ions are movable between the positive electrode 41 and the negative electrode 42 through the electrolyte layer. In this case, it is possible to achieve higher effects because leakage of the electrolytic solution is prevented, in particular.

The present technology described herein is not limited thereto, and is therefore modifiable in a variety of suitable ways.

For example, although the description has been given of the case where the battery device has a device structure of a wound type, the device structure of the battery device is not particularly limited, and may be of any other type, such as a stacked type or a zigzag folded type. In the device structure of the stacked type, the positive electrode and the negative electrode are alternately stacked with the separator interposed between the positive electrode and the negative electrode. In the device structure of the zigzag folded type, the positive electrode and the negative electrode are folded in a zigzag manner with the separator interposed between the positive electrode and the negative electrode.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantage. It is therefore intended that such changes and modifications be covered by the appended claims.

1. A secondary battery comprising:
an outer package member having an electrically conductive property, the outer package member having a through hole;
an electrode terminal disposed on an outer side of the outer package member and blocking the through hole;
an insulating sealing member disposed between the outer package member and the electrode terminal;
a battery device contained inside the outer package member; and
an insulating member disposed between the outer package member and the battery device, wherein
the outer package member includes a recessed part in which the through hole is provided, and, in the recessed part, the outer package member is bent to be recessed inward,
the recessed part has an opposed surface opposed to the battery device, and
the insulating member covers the opposed surface and is fixed to the opposed surface.

2. The secondary battery according to claim 1, wherein the insulating member is extended to an inner side relative to the opposed surface without closing the through hole.

3. The secondary battery according to claim 1, wherein the insulating member is extended to an outer side relative to the opposed surface.

4. The secondary battery according to claim 1, wherein the electrode terminal is contained inside the recessed part.

5. The secondary battery according to claim 1, wherein
the outer package member includes
a container part having an opening, and containing the battery device inside, and
a cover part having the recessed part and closing the opening, and
the cover part and the container part are joined to each other.

6. The secondary battery according to claim 1, wherein
the battery device includes a first electrode and a second electrode,
the first electrode is electrically coupled to the electrode terminal, and
the second electrode is electrically coupled to the outer package member.

7. The secondary battery according to claim 1, wherein the outer package member has a flat and columnar three-dimensional shape.

8. The secondary battery according to claim 1, wherein the outer package member comprises a metal can.

9. The secondary battery according to claim 1, wherein the secondary battery comprises a lithium-ion secondary battery.

10. The secondary battery according to claim 1, wherein the insulating film is adhered to the opposed surface, with or without an adhesive layer.

11. The secondary battery according to claim 1, wherein the insulating layer extends continuously and is fixed to a top surface of a cover part of the outer package member, outside of the recessed part.
